(19) United States
(12) Patent Application Publication
(10) Pub. No.: US 2016/0195176 A1
(43) Pub. Date: Jul. 7, 2016

(54) ADJUSTMENT APPARATUS FOR CHANGING THE COMPRESSION RATIO IN A COMBUSTION ENGINE

(71) Applicant: SCHAEFFLER TECHNOLOGIES AG & CO. KG, Herzogenaurach (DE)

(72) Inventors: Sebastian Zwahr, Obermichelbach (DE); Jens Schaefer, Herzogenaurach (DE)

(21) Appl. No.: 14/911,981

(22) PCT Filed: Jul. 7, 2014
(86) PCT No.: PCT/DE2014/200307

§ 371 Date: Feb. 12, 2016

(30) Foreign Application Priority Data
Aug. 14, 2013 (DE) 102013216181.6

(51) Int. Cl. F16H 35/00; F16H 1/46; F16H 1/28; F02D 15/00

(52) U.S. Cl. CPC F16H 35/008; F02D 15/00; F16H 1/46; F16H 1/28

(57) ABSTRACT

The invention relates to an adjustment apparatus (1) for changing the compression ratio in an internal combustion engine, comprising a driving means (2), at least one transmission (5) connected downstream of the driving means (2) and a drive shaft (7) connected downstream of the transmission (5), wherein the transmission (5) has at least two different transmission stiffness progressions between nominal load limits of 0 and 100%.

### CROSS REFERENCE TO RELATED APPLICATIONS

The present application is the U.S. national stage application pursuant to 35 U.S.C. § 371 of PCT/DE2014/200307, filed Jul. 7, 2014 which application claims priority to German Patent Application No. 10 2013 216 181.6, filed Aug. 14, 2013 which applications are incorporated herein by reference in their entireties.

### FIELD OF THE INVENTION

The invention relates to an adjustment device for changing the compression ratio in a combustion engine comprising a drive means, the drive means having at least one downstream gear and a gear connected to the downstream drive shaft.

### BACKGROUND OF THE INVENTION

Appropriate adjustment devices are known and they are used to adjust or rather change the compression ratio in particular in an Otto engine to achieve an operation of the combustion engine that is as efficient as possible. Such adjustment devices are typically connected to the combustion engine on the drive shaft side in a manner that i.e., e.g. they are directly connected to the crank mechanism of the combustion engine so that the relative position the pistons have to the cylinders of the combustion engine is adjustable to adapt the volume or rather the piston stroke assigned to this cylinder.

For this purpose, it is required to have appropriate adjustment devices for high frequency loads designed, particularly those, which are acting on the pistons due to high moving masses and gas forces. Furthermore, appropriate adjustment devices must ensure that the compression ratio is changed precisely and swiftly, in order to realize a smooth-running engine with uniform torque development.

Adjustment devices known from the prior art are mostly based on (electro) hydraulic or pneumatic operating principles. A disadvantage of this is for example that the operation of adjustment devices is typically connected directly with the operation of the combustion engine. As a result, the compression ration can only be changed during operation of the combustion engine. Similarly, the adjustment characteristic of respective adjustment devices depends strongly on the characteristics of the hydraulic or pneumatic medium used in the operation of the combustion engine. Furthermore, respective adjustment devices generally do not allow a satisfactory fixing of the set compression ratio. This in turn requires a relatively high need for regulation and control as well as energy. In addition, it has many disadvantages due to space constraints and production technology.

### SUMMARY OF THE INVENTION

The invention solves the problem by providing an improved adjustment device. To solve the problem, an adjustment device of the type mentioned above intends for the transmission to have at least two different transmission stiffness progressions between the nominal load limits of 0 and 100%.

The present invention is based on the idea to provide an adjustment device with a transmission or rather a gear stage with a non-linear transmission stiffness progression. As opposed to a transmission with linear transmission stiffness progression, the transmission stiffness of the corresponding transmission of the adjustment device according to the invention shows at least two different transmission stiffness progressions between the transmission specific nominal loads of 0 and 100%. Therefore, the transmission has generally different transmission stiffnesses or rather transmission stiffness progressions within the nominal load limits of 0.5 and 100% in at least two of the different nominal load ranges. Thus, the adjustment device according to the invention can be called an elastic transmission or rather a transmission with an elastic toothing. This is particularly caused by the transmission possessing backlash-free toothing with a typically comparatively lower transmission stiffness in a specific nominal load range, particularly in a low nominal load range, i.e., low loads acting on the transmission.

The non-linear transmission stiffness distribution arises from the fact that the transmission has at least two different transmission stiffness progressions between nominal load limits of 0 and 100%. Typically, the transmission has in a nominal load range between the nominal load limits of 0 and 100%, i.e., with relatively low loads acting on the transmission, a lower transmission stiffness compared with the high nominal load range between the nominal load ranges of 0 and 100%, i.e., with relatively high or rather maximum permissible loads acting on the transmission.

For example, the transmission may have a flatter transmission stiffness progression in a range between 0 and 30% nominal load, particularly in a range between 0 and 20% nominal load, preferably in a range between 0 and 10% nominal load than in a higher nominal range. The nominal load ranges between 0 and 30% nominal load can be seen as low nominal load ranges. The higher nominal load ranges can be seen respectively as high nominal load ranges. Preferably, the respective transmission stiffness progression can differ starting with a nominal load of 10%. Therefore, the transmission stiffness below the nominal load of 10% can be comparably flatter and above the nominal load of 10% it can be comparably steeper.

Therefore, at least two transmission stiffness curves can differ, particularly in its slope. At least these two transmission stiffness progressions are calculated preferably linear in reference to one specific nominal load range within the nominal load limits of 0 and 100%, i.e., these two show a constant stiffness progression in this particular nominal load range. The slope of a flatter transmission stiffness progression may be 70%, in particular 50%, preferably less than 30%, of the slope of a steeper transmission stiffness progression. The respective slopes of at least two transmission stiffness progressions may differ quantitatively significantly. This can be particularly illustrated by a diagram showing the transmission stiffness with the force or torque (y-axis) versus distance or angle (x-axis). The transmission in its intended embodiment according to the invention has at least two different transmission stiffness progressions within the nominal load limits of 0 and 100%. Therefore, it is a space-optimized, function-optimized and cost-optimized solution of a respective adjustment device. Furthermore, it can reduce noise during switching in torque loads with alternating direction.

In general, the transmission belonging to the adjustment device according to the invention must be understood as device for the translation (transformation) of motion quantities, particularly in connection with the translation of rotational speeds, rotational directions, torques and forces. Therefore, this includes all types of transmissions such as spur gears, planetary gears, and shaft gears. Furthermore, this includes even or uneven translating lever mechanisms.

The basic structure of the adjustment device according to the invention comprises a torque-generating drive means typically in the form of an electric motor which is coupled on the output side to a drive shaft. Therefore, when the drive means is trained as electric motor the adjustment device can be seen as an electromechanical actuator. The drive shaft is on the side of the gear drive next to at least one transmission downstream of the drive means or it is connected with it on the side of the gear drive. From the (last) transmission, there is on the output side an output shaft, which is connected with the combustion engine, i.e., to one of its components such as a crankshaft in a manner that it allows changing or adjusting the compression ratio of the combustion engine. If another transmission is downstream of the gear output side, then it is connected to the combustion engine from the output side of this output shaft, i.e., to an associated component such as a crankshaft and it is coupled in such a manner that the compression ratio of the combustion engine can be changed or rather adjusted.

This transmission or any other transmission that may be there can be designed in accordance with the transmission described above, i.e., it can also show at least two different transmission stiffness progressions between the nominal loads of 0 to 100% and therefore, it has a non-linear transmission stiffness progression. The use of multiple elastic transmissions, i.e., several transmissions with a non-linear transmission stiffness progression is particularly useful, if the adjustment device is faced with load situations of particularly strong alternating excitation. Alternatively, this or any other transmission optionally available can have a linear transmission stiffness progression between the nominal load limits of 0 and 100%, i.e., it does not show two different transmission stiffness progressions between the nominal load limits of 0 and 100%. Therefore, the other transmission can be a conventional transmission such as a planetary transmission with linear transmission stiffness progression.

Similarly, it is possible by a suitable design of two or more successively connected transmissions and therefore, the adjustment device, to realize a self-locking of these two gears. Therefore, the transmissions are switched successively, in that, due to the self-locking mechanism it maintains the actually set compression ratio in case the combustion engine malfunctions. Thus, it is possible to continue to operate the combustion engine without any significant limitations. The motor vehicle with this combustion engine can be upgraded safely in the workshop. For example, the self-locking system can be achieved by providing as a first transmission a planetary gear designed with a linear transmission stiffness progression and downstream as a second gear a shaft gear designed with a non-linear transmission stiffness progression.

Furthermore, examples of embodiments of the invention or the transmission according to the invention transmission(s), which each show a non-linear transmission stiffness progression under nominal load limits of 0 and 100% are described. The list is not exhaustive, many other than the gear types described, showing a non-linear transmission stiffness progression can be envisaged.

In a first example of an embodiment, the transmission, where appropriate, also the further transmissions, a planetary gear with a ring gear, a sun gear and at least two planetary wheels, whereby in assembled state at least one planetary wheel in the assembled state of the planetary gear is arranged or braced between the ring gear and the sun gear in a manner that it undergoes elastic deformation. An elastic deformation of a planetary wheel can be achieved for example by the fact that with at least one mating gear it shows a negative toothing backlash (overlap), while the other components of the planetary gear, i.e., particularly the remaining planetary wheels, the sun wheel and the ring wheel show a normal toothing backlash. The planetary wheel can be too large for the precise structural design of the planetary gear because of the structural design of the ring wheel and the sun wheel and therefore, it is elastically deformed or twisted when inserting or assembling the transmission.

For example, a planetary wheel in a non-inserted state, which seen in its cross-section is round or roundish in shape, can be deformed elastically in the inserted state, which seen in its cross-section is now oval or elliptical in shape. The elastic formability of the planetary wheel, which is required, can for example be realized by using elastic deformable material for the design of the planetary wheel such as plastic, particularly an elastomer or a metal or metal allow with a low e-module such as copper or a copper alloy. Furthermore, the elastic deformation of the planet gear can be realized by soft gear hub geometry.

In a second example of an embodiment, the transmission, where appropriate, also the further gear, is a shaft gear. Shaft gears also known as harmonic drives show typically a shaft generator in the shape of an elliptic disc, resting on the wave generator, belt-like, deformable, and provided with an outer-toothed element and a rigid, outer ring with internal toothing. The external tooth system of the deformable element has typically fewer teeth than the inner tooth system of the outer ring. The shaft gear may be in a so-called flat or pot design. The shaft generator may be in floating position.

To detect the exact rotational position, in particular the angular position, the general position of the output shaft for the adjustment device, it is advantageous if a sensor to detect the rotational position of the output shaft is assigned to the output shaft. The sensor provides appropriate sensor signals relating to the current rotational position, in particular the angular position of the output shaft, based on which the adjustment device can be controlled or regulated. The rotational position of the output shaft can be determined relative to reference point freely selectable on the adjustment device. It is a particular advantage, if the sensor is arranged on the output shaft, i.e., for example, it is mechanically connected with the output shaft. The rotational position, particular angular position of the output shaft can be detected at any time, i.e., particularly in the event of malfunction of e.g. the adjustment device.

It is possible to connect a clutch, particularly an Oldham clutch between the drive means and its downstream transmission. Through the clutch, the drive shaft coming from the drive means can be disconnected from the downstream transmission or downstream transmissions. The use of an Oldham coupling has the advantage that the overall construction of the adjusting device can be kept comparatively small despite the use of a coupling. This follows from the compact structural design of appropriate Oldham couplings. In general, however, other types of couplings can be used.

Furthermore, the invention relates to a device for changing the compression ratio of a combustion engine, comprised of a least one of the above-referenced adjustment devices, wherein the adjustment device is connected through a drive shaft to a component, which is part of the combustion engine, such as the crank mechanism or the crankshaft respectively, and a control device assigned to the adjustment device for regulating or rather controlling the operation of the adjustment device. With regard to the device according to the invention, all statements concerning the adjustment device and their possible embodiments apply analogous.

### BRIEF DESCRIPTION OF THE DRAWINGS

One embodiment example of the invention is illustrated in the drawing and will be described in more detail below. The figures show:

FIG. 1 is an adjustment device in accordance with the embodiment of the invention,

FIG. 2 is a curve of the transmission stiffness for a transmission with a non-linear transmission stiffness progression and a transmission with a linear transmission stiffness progression and

FIG. 3 is a schematic diagram of a planetary gear in accordance with the embodiment of the invention.

### DETAILED DESCRIPTION

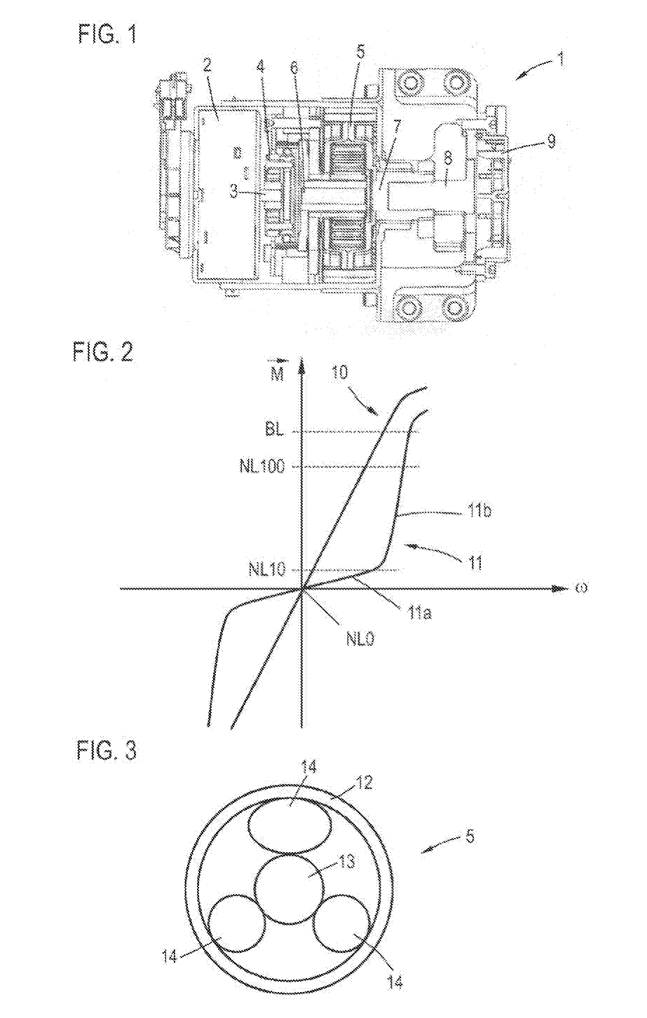

FIG. 1 shows an adjustment device in accordance with the embodiment of the invention, Adjustment device 1 is part of a device (not shown) to change the compression ratio in a combustion engine (not shown), particularly in an Otto engine of a motor vehicle (not shown). Therefore, the adjustment device 1 is connected in a manner with the combustion engine respectively one of its associated component, particularly a component of the crank mechanism such as the crankshaft, that an adjustment or change of the compression ratio of the combustion engine can be realized. Furthermore, the device is a control unit (not shown) assigned to the adjustment device 1 to regulate or control the operation of the adjustment device 1.

The adjustment device 1 is comprised of several components or assembly groups. Moreover, only the components or assembly groups of the adjustment device 1 essential for the principle according to the invention are described in more detail. This includes a drive means 2 in the form of an electric motor. Therefore, the adjustment device 1 can be considered as an electromechanical actuator. From drive means 2 is a drive shaft 3 transmitting torque, which is connected to a first transmission 4 or a first transmission stage on the side of the drive. Between the drive means 2 and the first gear 4, a clutch (not shown), in particular an Oldham clutch may be provided.

A second transmission 5 or a second transmission stage is downstream of the first transmission 4. For this purpose, the first transmission 4 is connected through shaft 6 with the drive side of the second transmission 5. From the second transmission 5, an output shaft 7 is on the output side, which is connected directly or indirectly to the combustion engine or one of its assigned components. In particular, it is possible that the first transmission 4 or the shaft 6 on its output side is connected to the first gear of the second transmission 5. In the embodiment of the second transmission 5 with reference to FIG. 3 described below as an elastic planetary gear can therefore for example production-related centering errors of the sun gear 14 (cf. FIG. 3) to the planetary gears 13 can be balanced using toothing backlash. The two transmissions 4, 5 are connected in a manner as to realize a self-locking effect. The two transmissions 4, 5 are sequentially switched, so that in the event of a malfunction of the internal combustion engine, the current setting of the compression ratio is maintained by the adjustment device 1.

The output shaft 7 is connected mechanically through an axial projection 8 to a rotary position sensor 9, through which the rotational position, in particular the angular position of the output shaft 7, can be detected. The sensor signals transmitted by the rotational position sensor 9 are important for the regulation or control of the adjustment device 1.

The first transmission 4 is a conventional transmission with a linear transmission stiffness progression between the transmission-specific nominal load limits of 0 and 100% (cf. FIG. 2, curve 10). The second gear 5 is a so-called elastic transmission, which shows two different transmission stiffness curves between the transmission-specific nominal load limits of 0 and 100% (cf. FIG. 2, curve 11). Therefore, the second gear 5 shows a non-linear transmission stiffness progression. As becomes apparent from the following description of FIG. 2, an elastic transmission must be understood as a transmission with a comparably lower transmission stiffness in the range of lower loads.

FIG. 2 shows a curve of transmission stiffness for a transmission with a non-linear transmission stiffness progression, i.e., for the second transmission 5, and a transmission with a linear transmission stiffness progression, i.e., for the first transmission 4. FIG. 2 shows a plotting of the torque (y-axis) on the respective transmissions 4, 5 as a function of the angular position (x-axis). In addition, the nominal load limits of 0 and 100% (NLO, NL100) as well as the breaking load (BL) are plotted on the y-axis. The maximum nominal load limit of 100% corresponds to approximately 70% of the breaking load. The area to the left of the y-axis indicates the negative direction of the load, the area to the right of the y-axis shows the positive direction of the load. In the coordinate system, the torque is 0 Nm.

First, the gear stiffness distribution of the conventional first transmission 4 should be considered (cf. curve 10). As can be seen, there is a linear relationship between the angular position and torque, i.e., the torque increase is linear between the nominal load limits of NL0 and NL100 proportionally with the angular position. Curve 10 represents the transmission stiffness progression of the first transmission 4; i.e., it also shows a (largely) constant slope between the nominal load limits NL0 and NL100.

The situation is different in curve 11, which represents the transmission stiffness progression of the second transmission 5. As seen, curve 11 shows different slopes, i.e., curve segments 11a, 11b with different slopes. Compared to curve 10, there are no or only sections or regions of any (largely) constant slopes between the nominal load limits NL0 and NL100 here.

The transmission stiffness of the second transmission 5 shows in the region of small nominal loads (cf. curve section 11a), i.e., below a nominal load of 10% a significantly lower gradient and therefore, clearly a flatter curve than in the area of larger loads (cf. curve section 11b), i.e., above the nominal load of 10% (NL10). The transmission stiffness of the second transmission 5 is in the range of smaller nominal loads, i.e., particularly below nominal loads of less than 10% less than one third of the transmission stiffness the second transmission 5 shows in the range of high nominal loads, i.e., particularly above nominal loads that are greater than 10%. It should be noted that the flat or steep curve of the transmission stiffness considered in isolation is linear (cf. the linear progression of the curve sections 11a, 11b).

Although in FIG. 1 a first gear 4 with a linear curve of the transmission stiffness and a second gear 5 with a non-linear curve of the transmission stiffness are shown as parts of the adjustment device 1, it is also possible to design the first gear 4 equally with a corresponding non-linear curve of the transmission stiffness, i.e., in accordance with the second gear 5. It is also conceivable that the second gear 5 is installed upstream from the first transmission 4.

The first transmission 4 can be a conventional planetary gear. The second transmission 5 can be a shaft gear in flat-type or pot design. If needed, it can be a floating shaft generator or a specially modified planet gear.

FIG. 3 shows a schematic diagram of such modified planetary gear in accordance with the embodiment of the invention. The planetary gear shows the standard components comprised of ring gear 12 with internal toothing, a sun gear 13 with external toothing and centered in the ring gear 12 and three planetary gears 14 each with external toothing. The external toothing of planet gears 14 meshes with the external toothing of the sun gear 13 as well as with the internal toothing of the ring gear 12. The sun gear 13 is mounted on a shaft in a non-rotatable manner. In addition, the planetary gears are mounted in a rotatable manner.

In reference to FIG. 1, the sun gear 13 is mounted on shaft 6 in a non-rotatable manner. The ring gear 12 is fixed, i.e., it cannot turn.

In particular, the special progression of the transmission stiffness of the second transmission 5 explained in connection with FIG. 2 can be achieved in an embodiment as planetary gear by dimensioning the planetary gear 14, i.e., in FIG. 3 the upper planetary gear 14, larger compared to the remaining planetary gears 14 and by making it out of elastic formable material such as elastomer. To install this planetary gear 14 in the transmission 5 between the ring gear 12 and the sun gear 13, the planetary gear 14 must be elastically deformed. This elastic deformation of the planetary gear 14 leads to the elliptic shape of planetary gear 14 as shown in FIG. 3. The deformed planetary gear 14 shows with its mating gear, i.e., for example the sun gear 13, a negative backlash (overlap). All other wheels of the planetary gear otherwise show a normal backlash. The elastic deformation of the planetary gear 14 can also be implemented as respective soft gear wheel hub geometry.

Based on the embodiment of transmission 5, the adjustment device 1 according to the invention has at least two different transmission stiffness progressions within the transmission-specific nominal load limits of 0 and 100%. It presents a solution that optimizes space, costs, and function. In addition, it offers the possibility to reduce noise when switching the system in case of a torque load with changing direction.

### REFERENCE NUMERICAL LIST

1 Adjustment device
2 Drive means
3 Drive shaft
4 Transmission
5 Transmission
6 Shaft
7 Output shaft
8 Approach
9 Rotary position
10 Curve
11 Curve
11a Curve section
11b Curve section
12 Ring gear
13 Sun gear
14 Planetary gear

We claim:

1. An adjustment apparatus for changing the compression ratio in an internal combustion engine, comprising at least one drive means , a downstream transmission , as and a drive shaft connected downstream to the transmission wherein the transmission has at least two different transmission stiffness progressions between nominal load limits of 0 and 100%.

2. The adjustment device according to claim 1, wherein the downstream transmission includes a flatter transmission stiffness progression between a range of nominal load between 0 and 30%, than in any nominal load ranges that lie above 30%.

3. The adjustment device according to claim 1 , wherein at least two stiffness progressions differ in their gradient.

4. The adjustment device according to claim 3, wherein the gradient of a flatter stiffness curve is 70% of the gradient of a steeper stiffness progression.

5. The adjustment device according to claim 1, upstream further comprising an additional transmission positioned upstream or downstream of downstream transmission , wherein the additional transmission includes a linear transmission stiffness progression between nominal load limits of 0 and 100%.

6. The adjustment device according to claim 1, wherein the transmission is a planetary gear with a ring wheel , a sun wheel and at least two planetary wheels , whereby at least on planetary wheel is connected in the assembled state of the planetary gear between the ring wheel and the sun wheel in a manner that it is elastically deformed.

7. The adjustment device according to claim 1 , wherein the downstream transmission is a shaft gear.

8. The adjustment device according to claim 1, wherein a sensor assigned to the output shaft to detect the pivot bearing of the output shaft is particularly arranged on the output shaft .

9. The adjustment device claim 1, further comprising a clutch, wherein the clutch is connected between the drive means and the downstream transmission and the additional transmission.

10. A device for changing the compression ratio in an internal combustion engine comprised at least of one adjustment device according to claim 1, wherein the adjustment device is connectable or connected through its assigned output shaft to a component of the internal combustion engine and includes a control unit assigned to the adjustment device to control the operation of the adjustment device .

11. The adjustment device according to claim 2, wherein the transmission possesses a flatter transmission stiffness progression between a range of nominal load between 0 and 20% than in any nominal load ranges that lie above 20%.

12. The adjustment device according to claim 2, wherein the transmission possesses a flatter transmission stiffness progression between a range of nominal load between 0 and 10% than in any nominal load ranges that lie above 10%.

13. The adjustment device according to claim 6, wherein the additional transmission is a planetary gear with a ring wheel, a sun wheel and at least two planetary wheels, whereby at least one planetary wheel is connected in the assembled state of the planetary gear between the ring wheel and the sun wheel in a manner that it is elastically deformed.

14. The adjustment device according to claim 7, further comprising an additional transmission wherein the additional transmission is a shaft gear.

15. The adjustment device according claim 9, wherein the clutch is an Oldham clutch connected between the drive means and the downstream transmission.
